(19) United States
(12) Patent Application Publication
(10) Pub. No.: US 2014/0009414 A1
(43) Pub. Date: Jan. 9, 2014

(54) Symbol Input Devices, Symbol Input Method and Associated Computer Program Product

(71) Applicant: MSTAR SEMICONDUCTOR, INC., Hsinchu Hsien (TW)

(72) Inventors: Hung-Chi Huang, Hsinchu Hsien (TW); Ling-Hsuan Huang, Hsinchu Hsien (TW)

(73) Assignee: MStar Semiconductor, Inc., Hsinchu Hsien (TW)

(21) Appl. No.: 13/855,867

(22) Filed: Apr. 3, 2013

(30) Foreign Application Priority Data
Jul. 9, 2012 (TW) 101124599

(51) Int. Cl. G06F 3/041

(52) U.S. Cl. CPC G06F 3/041
USPC 345/173

(57) ABSTRACT

A symbol input device, applied to a touch screen that generates a detection result according to touch points, includes a receiving unit, a storage unit and a control unit. The receiving unit receives the detection result, the storage unit stores a look-up table, and the control unit determines a symbol from the look-up table according to the number of the touch points on the touch screen indicated in the detection result.

### CROSS REFERENCE TO RELATED PATENT APPLICATION

This patent application is based on Taiwan, R.O.C. patent application No. 101124599 filed on Jul. 9, 2012, the subject matter of which is incorporated herein by reference.

### FIELD OF THE INVENTION

The present invention relates to a symbol input device, and more particularly, to a symbol input device applied to a touch screen, a symbol input method and an associated computer program product.

### BACKGROUND OF THE INVENTION

With present day technology a user can transmit a desired character or symbol to a television (TV) and displaying it on the TV screen via an input device (e.g., a touch panel) when the TV is, e.g., a network or “smart” TV. However, since the area of a button (or a touch button) of the input device is generally small, the user has to lower his head to watch the input device to input the character or symbol, and pick up his head repeatedly to check whether the character or symbol displayed on the TV screen is correct. Accordingly, not only is the inconvenience of the user is increased, but an input speed of the user is also reduced. In addition, when the input device applies handwriting input with the use of the touch screen, a complex program and large memory capacity are needed to identify the handwriting input thus increasing cost of hardware.

### SUMMARY OF THE INVENTION

Therefore, one object of the present invention is to provide a symbol input device that provides a user with a fast and convenient input approach that requires no additional hardware cost to solve the problem of the prior art.

According to an embodiment of the present invention, a symbol input device applied to a touch screen is provided. The touch screen, generating a detection result according to touch points, comprises a receiving unit, a storage unit and a control unit. The receiving unit receives the detection result, the storage unit stores a look-up table, and the control unit determines a symbol from the look-up table according to the number of the touch points on the touch screen indicated in the detection result.

According to another embodiment of the present invention, a symbol input method applied to a touch screen that generates a detection result according to touch points comprises: receiving the detection result; providing a storage unit for storing a look-up table; and determining a symbol from the look-up table according to the number of the touch points indicated in the detection result.

According to yet another embodiment of the present invention, a computer program product applied to a touch screen for generating a detection result according to touch points is loaded by a processor to perform steps of: receiving the detection result; storing a storage unit that is stored with a look-up table; and determining a symbol from the look-up table according to the number of the touch points on the touch screen indicated in the detection result.

The advantages and spirit related to the present invention can be further understood via the following detailed description and drawings.

### BRIEF DESCRIPTION OF THE DRAWINGS

FIG. 1 is a schematic diagram of a television (TV) and an input device in accordance with an embodiment of the present invention.

FIG. 2 is a schematic diagram of structure of a symbol input device in accordance with an embodiment of the present invention.

FIG. 3 is a schematic diagram of a touch screen division approach in accordance with an embodiment of the present invention.

FIG. 4 is a schematic diagram of a touch screen division approach in accordance with an embodiment of the present invention.

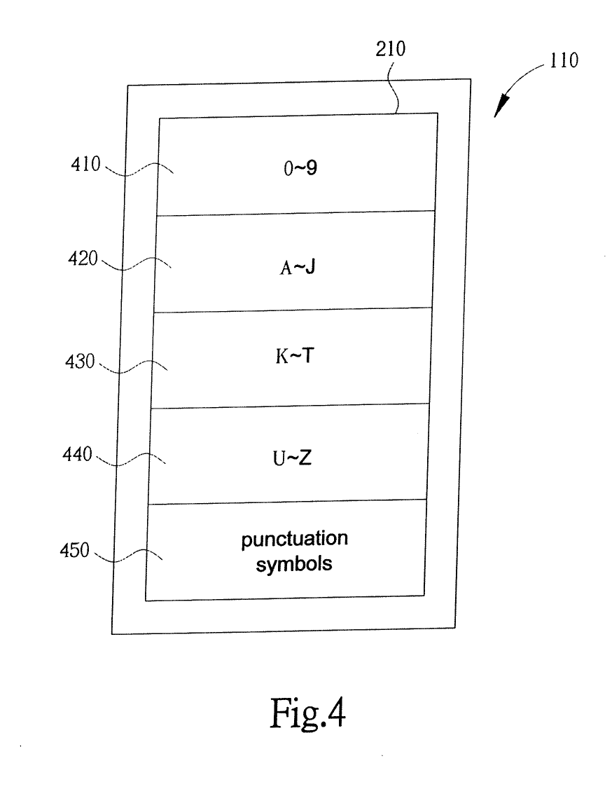

FIG. 5 is a schematic diagram of a touch screen division approach in accordance with an embodiment of the present invention.

FIG. 6 is a flow chart of a symbol input method in accordance with an embodiment of the present invention.

FIG. 7 is a flow chart of operations performed after a computer program product is loaded by a processor in accordance with an embodiment of the present invention.

### DETAILED DESCRIPTION OF THE PREFERRED EMBODIMENT

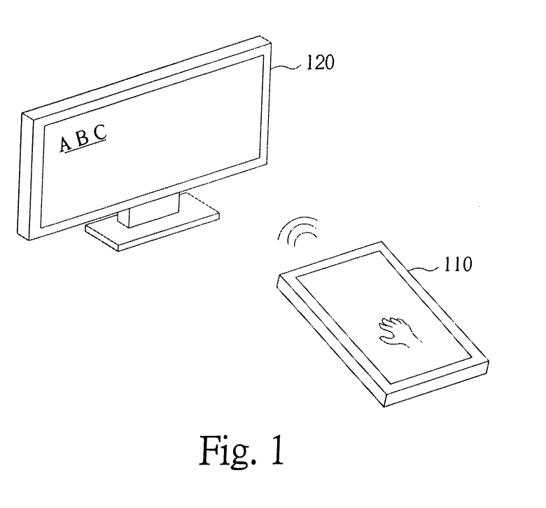

FIG. 1 shows a schematic diagram of a TV 120 and a symbol input device 110 in accordance with an embodiment of the present invention. The symbol input device 110 is a tablet computer having a touch screen, and a user can input a symbol via the symbol input device 110, and transmit the inputted symbol to the TV 120 for displaying the symbol.

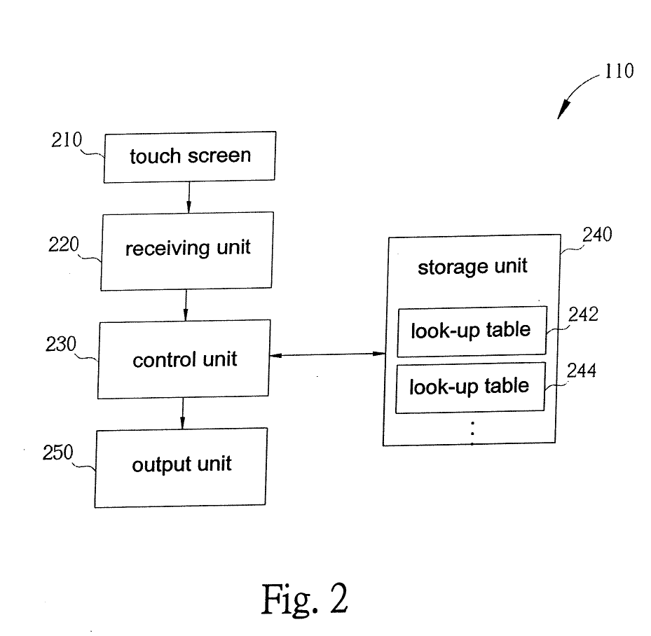

FIG. 2 shows a schematic diagram of structure of the symbol input device 110 in accordance with an embodiment of the present invention. The symbol input device 110 comprises a touch screen 210, a receiving unit 220, a control unit 230, a storage unit 240 and an output unit 250. The storage unit 240 comprises at least a look-up table 242 and a look-up table 244. The look-up table 242 and the look-up table 244 correspond to different symbol input paradigms, and both comprise a plurality of sub-look-up tables (not shown). When the user presses the touch screen 210, a detection result is generated. The receiving unit 220 receives the detection result, and the control unit 230 determines a symbol according to one of the look-up tables stored in the storage unit 240. It is noted that the several describe “units” may be implemented in hardware, e.g., in an application specific integrated circuit (ASIC) encoded with instructions or logic to perform the functions described herein.

As to operations of the symbol input device 110, the user selects a to-be-input symbol (e.g., Chinese, English, Japanese, numbers, etc.) or a desired input method by the touch screen 210, and an electronic selection list is displayed on the touch screen for selection. For example, when the user selects an English input mode, the control unit 230 selects the look-up table 242 for subsequent use. When the user selects a Japanese input mode, the control unit 230 selects the look-up table 244 for subsequent use. In addition, the output unit 250 provides prompt information of different numbers of touch points and corresponding symbols to the TV 120 to display the prompt information on the screen of the TV for user's reference. For example, when the user selects the English input mode, the screen of the TV 120 displays a look-up table instructing an input manner corresponding to each letter.

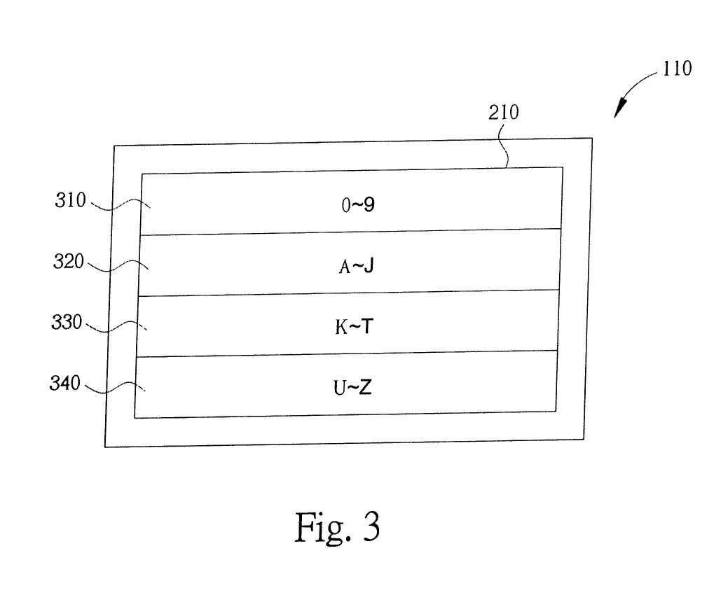

Suppose that the user currently selects the English input mode and the control unit 230 selects the look-up table 242 for subsequent use. Referring to FIG. 3, the look-up table 242 comprises four sub-look-up tables respectively corresponding to different non-overlapping areas 310-340 on the touch screen 210. The area 310 is for inputting number symbols 0 to 9, the area 320 is for inputting English letters A to J, the area 330 is for inputting English letters K to T, and the area 340 is for inputting English letters U to Z. For example, four sub-look-up tables (Table 1 to Table 4) are shown below for reference.

TABLE 1

| | Number of touch points | | | | | | | | | |
|---|---|---|---|---|---|---|---|---|---|---|
| | 1 | 2 | 3 | 4 | 5 | 6 | 7 | 8 | 9 | 10 |
| Corresponding | 1 | 2 | 3 | 4 | 5 | 6 | 7 | 8 | 9 | 0 |
| symbol | | | | | | | | | | |

TABLE 2

| | Number of touch points | | | | | | | | | |
|---|---|---|---|---|---|---|---|---|---|---|
| | 1 | 2 | 3 | 4 | 5 | 6 | 7 | 8 | 9 | 10 |
| Corresponding | A | B | C | D | E | F | G | H | I | J |
| symbol | | | | | | | | | | |

TABLE 3

| | Number of touch points | | | | | | | | | |
|---|---|---|---|---|---|---|---|---|---|---|
| | 1 | 2 | 3 | 4 | 5 | 6 | 7 | 8 | 9 | 10 |
| Corresponding | K | L | M | N | O | P | Q | R | S | T |
| symbol | | | | | | | | | | |

TABLE 4

Number of touch points

| | 1 | 2 | 3 | 4 | 5 | 6 |
|---|---|---|---|---|---|---|
| Corresponding | U | V | W | X | Y | Z |
| symbol | | | | | | |

The abovementioned Table 1 to Table 4 are schematic diagrams of four sub-look-up tables of the look-up table 242. The sub-look-up table (Table 1) corresponds to the area 310, the sub-look-up table (Table 2) corresponds to the area 320, the sub-look-up table (Table 3) corresponds to the area 330, and the sub-look-up table (Table 4) corresponds to the area 340. The range covered by the different areas on the touch screen 210 is displayed for a user's reference.

When the user wishes to input four symbols “PAT2” on the TV screen, he presses the area 330 on the touch screen 210 using six fingers at the same time, or continuously (i.e., sequentially) presses the area 330 on the touch screen 210 six times. For purposes of explanation, assume an interval between two continuous presses is smaller than a predetermined time period. At this time, the touch screen 210 generates a detection result of positions and numbers of the touch points. The receiving unit 220 receives the detection result, and the control unit 230 determines the symbol “P” from Table 3 according to the number of the touch points in the area 330 indicated by the detection result. The symbol “P” is transmitted from the output unit 250 to the TV 120 for display. After that, the user presses the area 320 on the touch screen 210 by a single finger, and the control unit 230 determines the symbol “A” from Table 2 according to the number of touch points in the area 320 indicated by the detection result received by the receiving unit 220, and the symbol “A” is transmitted from the output unit 250 to the TV 120 for display. After that, the user presses the area 330 on the touch screen 210 by his ten fingers at the same time, or continuously presses the area 330 on the touch screen 210 ten times. At this time, the control unit 230 determines the symbol “T” from Table 3 according to the number of the touch points in the area 330 indicated by the detection result received by the receiving unit 220, and the symbol “T” is transmitted from the output unit 250 to the TV 120 for display. The user presses the area 310 on the touch screen 210 by his two fingers at the same time, or continuously presses the area 310 on the touch screen 210 twice. At this time, the control unit 230 determines the symbol “2” from Table 1 according to the number of the touch points in the area 310 indicated by the detection result received by the receiving unit 220, and the symbol “2” is transmitted from the output unit 250 to the TV 120 for display. Accordingly, the user easily transmits and displays the four symbols “PAT2” on the TV screen.

It is to be noted that the area division manner and the number of sub-look-up tables contained in the look-up table 242 shown in FIG. 3 are disclosed for illustration purposes, and these shall not be construed as limiting the present invention. In other embodiments, the touch screen 210 is divided into other numbers of areas (e.g., three, five or more than five areas), and each area corresponds to a sub-look-up table. For example, suppose that the user currently selects the English input mode, the control unit 230 selects the look-up table 242 to determine a symbol to be outputted, and the look-up table 242 contains five sub-look-up tables. The five sub-look-up tables respectively correspond to a plurality of non-overlapping areas 410 to 450 on the touch screen 210. The area 410 is for inputting number symbols 0 to 9, the area 420 is for inputting English letters A to J, the area 430 is for inputting English letters K to T, the area 440 is for inputting English letters U to Z, and the area 450 is for inputting punctuation symbols. The sub-look-up tables corresponding to the areas 410 to 440 refer to the abovementioned Table 1 to Table 4, and the sub-look-up table corresponding to 450 refers to Table 5 below.

TABLE 5

| | Number of touch points | | | | | | | | | |
|---|---|---|---|---|---|---|---|---|---|---|
| | 1 | 2 | 3 | 4 | 5 | 6 | 7 | 8 | 9 | 10 |
| Corresponding | , | . | ? | “ | ! | # | $ | % | ( | ) |
| symbol | | | | | | | | | | |

In addition, in other embodiments of the present invention, the touch screen contains at least another area for inputting function instructions, e.g., “enter”, “backspace”, “delete”, “escape” keys on a computer keyboard, and such design variations are within the scope of the present invention.

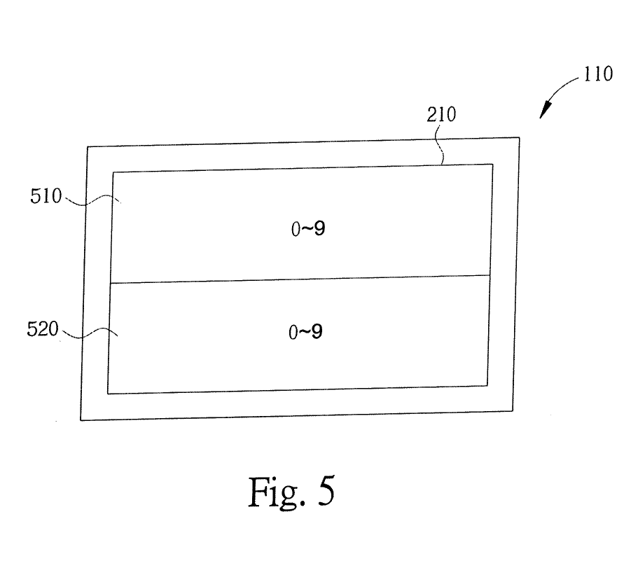

Suppose that the user currently selects the Japanese input mode, and the control unit 230 selects the look-up table 244 for subsequent use. The look-up table 244 contains correspondence relationships between all Japanese letters and corresponding index values. In this embodiment, referring to FIG. 5, the touch screen 210 is divided into two different non-overlapping areas 510 to 520. Both of the areas 510 and the area 520 are for inputting numbers 0 to 9, so that the user can input a double-digit index value. For example, suppose that the

Japanese letter “ [symbol] ” corresponds to an index value “23”, the user first presses the area 510 on the touch screen 210 by his two fingers at the same time, or continuously presses the area 510 on the touch screen 210 twice during a fixed time period to obtain a tens digit “2” of the index value. After that, the user presses the area 520 on the touch screen 210 using three fingers at the same time, or continuously (i.e., sequentially) presses the area 520 on the touch screen 210 three times during a fixed time period to obtain a units digit “3” of the index value. The control unit 230 determines the symbol “ [symbol] ” from the look-up table 244 via the index value. The determined symbol “ [symbol] ” is transmitted from the output unit 250 to the TV 120 and is displayed on the TV screen. In addition, the touch screen 210 displays an index value corresponding to each Japanese character and a range of the area 510 and the area 520 for user's reference.

It is to be noted that the area division manner shown in FIG. 5 is for illustration purposes, and it shall not be construed as limiting the present invention. In other embodiments, the touch screen 210 in FIG. 5 is divided into other numbers of areas, of which two are for inputting index values and the remaining ones are for inputting symbols or numbers (corresponding look-up tables referring to the abovementioned Table 1 and Table 5), and such design variations are within the scope of the present invention.

In addition, although numbers, English letters, Japanese letters and punctuation symbols are disclosed for example in the foregoing embodiments, other characters and symbols are also applied to the symbol input method according to the present invention. A person having ordinary skills in the art can easily learn such applications after having read the foregoing disclosure, so that associated details are not described again.

In addition, although the symbol input device 110 shown in FIG. 1 only has a touch screen 210, the symbol input device 110 is designed as having two touch screens in other embodiments (e.g., both the front and back of a tablet computer have one touch screen), and both of the two touch screens can be regarded as the foregoing symbol input area. The design variations are within the scope of the present invention.

As mentioned above, the symbol input device 110 is configured to enable the user to rapidly input a desired symbol, and the user can thus more easily focus on the TV screen during the symbol input process without periodically lowering his head to check on the button (or the touch button), thus increasing convenience to the user to input a symbol. In addition, since the symbol input device 110 only needs a simple structure to realize the abovementioned functions, design and manufacture cost are reduced.

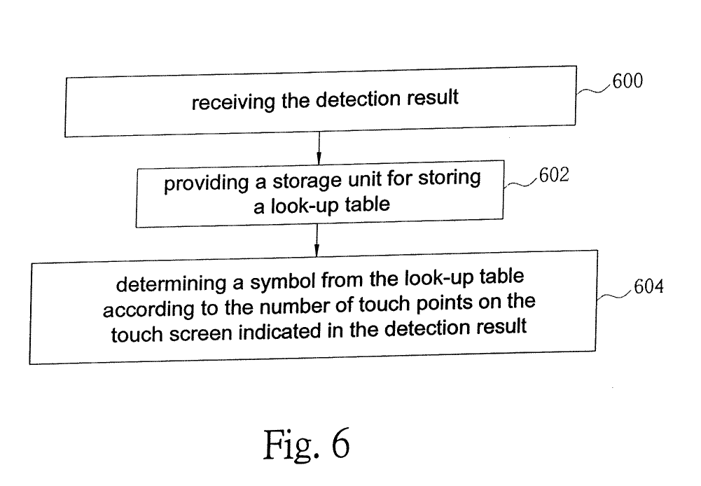

FIG. 6 shows a flow chart of a symbol input method in accordance with an embodiment of the present invention. Referring to the symbol input device shown in FIG. 1, FIG. 2 and the flow chart shown in FIG. 6, steps of the symbol input method are described below. In Step 600, a detection result on a touch screen is received. In Step 602, a storage unit is provided to store a look-up table. In Step 604, a symbol is determined from the look-up table according to the number of touch points on the touch screen indicated in the detection result.

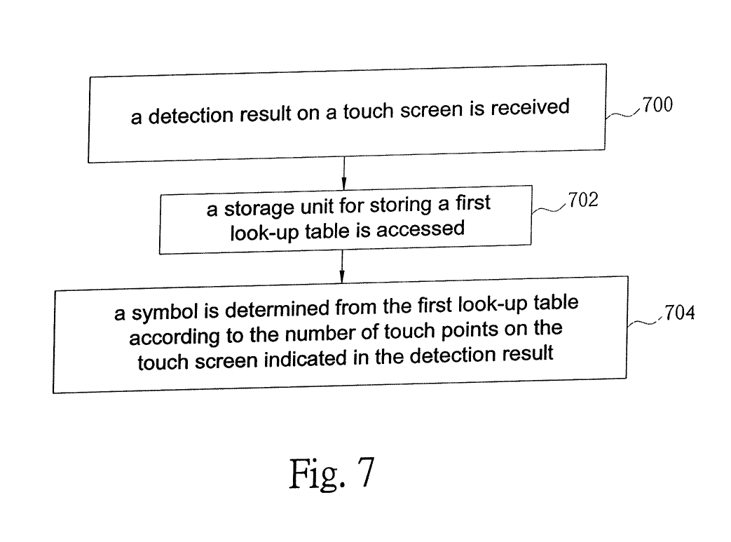

In addition, the symbol input method is performed via a computer program of the symbol input device 110, and the computer program is a computer program product that is provided on the network for the user to download. More specifically, FIG. 7 shows a flow chart of operations performed after a computer program product is loaded by a processor in accordance with an embodiment of the present invention. Steps of the flow chart in FIG. 7 are described below. In Step 700, a detection result on a touch screen is received. In Step 702, a storage unit for storing a first look-up table is accessed. In Step 704, a symbol is determined from the first look-up table according to the number of touch points on the touch screen indicated in the detection result.

In conclusion, according to the symbol input device, the symbol input method and the associated computer program product, a symbol is determined from a look-up table according to the number of touch points on a touch screen indicated in the detection result. Therefore, convenience is increased to the user to input the symbol, and design and manufacture cost are reduced since the foregoing function is realized via a simple structure of the symbol input device.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A symbol input device, applied to a touch screen that generates a detection result according to touch points, the symbol input device comprising:
a receiving unit, for receiving the detection result;
a storage unit, for storing a first look-up table; and
a control unit, for determining a symbol from the first look-up table according to the number of touch points on the touch screen indicated in the detection result.

2. The symbol input device as claimed in claim 1, wherein the storage unit stores a second look-up table, and the control unit determines to apply the first look-up table or the second look-up table according to a user input; wherein when it is determined to apply the first look-up table, the control unit determines the symbol from the first look-up table according to the number of the touch points on the touch screen indicated in the detection result; and when it is determined to apply the second look-up table, the control unit determines another symbol from the second look-up table according to the number of the touch points on the touch screen indicated in the detection result.

3. The symbol input device as claimed in claim 1, wherein the first look-up table comprises a plurality of sub-look-up tables, which respectively correspond to a plurality of non-overlapping areas on the touch screen and comprise corresponding relations between the number of touch points and different symbols, and the control unit determines the symbol from a corresponding sub-look-up table according to the number of touch points within a predetermined area among the plurality of areas on the touch screen indicated in the detection result.

4. The symbol input device as claimed in claim 1, wherein the number of touch points is a total number of times that a position is sequentially pressed or a total number of touch points at different positions that are pressed within a predetermined time period.

5. The symbol input device as claimed in claim 1, wherein the control unit calculates the number of touch points within a first area on the touch screen and the number of touch points within a second area on the touch screen indicated in the detection result to obtain an index value, and the control unit determines the symbol from the first look-up table according to the index value.

6. The symbol input device as claimed in claim 5, wherein the index value comprises a first digit and a second digit, and the number of the touch points within the first area and the number of the touch points within the second area are respectively regarded as the first digit and the second digit.

7. The symbol input device as claimed in claim 1, further comprising:
an output unit, for transmitting the symbol determined by the control unit to a television (TV) and displaying the symbol on a screen of the TV.

8. The symbol input device as claimed in claim 7, wherein the output unit transmits prompt information of different numbers of touch points and corresponding symbols to display the prompt information on the screen of the TV.

9. A symbol input method, applied to a touch screen that generates a detection result according to touch points, the symbol input method comprising:
receiving the detection result;
providing a storage unit for storing a first look-up table; and
determining a symbol from the first look-up table according to the number of touch points on the touch screen indicated in the detection result.

10. The method as claimed in claim 9, the storage unit storing a second look-up table, the symbol input method further comprising:
determining whether to apply the first look-up table or the second look-up table according to a user input;
determining the symbol from the first look-up table according to the number of the touch points on the touch screen indicated in the detection result when it is determined to apply the first look-up table; and
determining another symbol from the second look-up table according to the number of the touch points on the touch screen indicated in the detection result when it is determined to apply the second look-up table.

11. The method as claimed in claim 9, wherein the first look-up table comprises a plurality of sub-look-up tables, which respectively correspond to a plurality of non-overlapping areas on the touch screen and comprise corresponding relations between the number of touch points and different symbols; and the step of determining the symbol comprises determining the symbol from a corresponding sub-look-up table according to the number of touch points within a predetermined area among the plurality of areas on the touch screen indicated in the detection result.

12. The method as claimed in claim 9, wherein the number of touch points is a total number of times that a position is continuously pressed or a total number of touch points at different positions that are pressed within a predetermined time period.

13. The method as claimed in claim 9, wherein the step of determining the symbol comprises:
calculating the number of touch points within a first area on the touch screen and the number of touch points within a second area on the touch screen indicated in the detection result to obtain an index value; and
determining the symbol from the first look-up table according to the index value.

14. The method as claimed in claim 13, wherein the index value comprises a first digit and a second digit, and the number of the touch points within the first area and the number of the touch points within the second area are respectively regarded as the first digit and the second digit.

15. The method as claimed in claim 9, further comprising:
transmitting the symbol to a TV and displaying the symbol on a screen of the TV.

16. The method as claimed in claim 15, further comprising transmitting prompt information of different numbers of touch points and corresponding symbols to display the prompt information on the screen of the TV.
